(19) United States
(12) Patent Application Publication
(10) Pub. No.: US 2008/0086285 A1
(43) Pub. Date: Apr. 10, 2008

(54) System and method for monitoring complex distributed application environments

(76) Inventors: George Gombas, Castle Rock, CO (US); Stephen Buck, Boulder, CO (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/378,742

(22) Filed: Mar. 4, 2003

Related U.S. Application Data
(60) Provisional application No. 60/361,579, filed on Mar. 4, 2002.

(51) Int. Cl. G06F 17/40; G06F 15/00

(52) U.S. Cl. 702/187

(57) ABSTRACT

A system and method for monitoring applications is described. Embodiments of the present invention support three layers of monitoring: selected monitoring of applications and their transactions; SQL monitoring through JDBC; and attribute and metric monitoring at a sub-component level.

### RELATED APPLICATIONS

This application claims priority to U.S. provisional patent application No. 60/361,579, entitled System and Methodfor Monitoring Complex Distributed Application Environments, filed on Mar. 4, 2002. This provisional patent application is incorporated herein by reference.

### FIELD OF THE INVENTION

The present invention relates to systems and methods for monitoring software and/or hardware performance.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the Drawings wherein:

FIG. 1 is an architectural diagram of one embodiment of the present invention;

FIG. 2 is an application diagram in accordance with one embodiment of the present invention;

FIG. 3 represents a metrics tab view in accordance with one embodiment of the present invention; and

FIG. 4 is a diagram of a security system as implemented by one embodiment of the present invention.

### DETAILED DESCRIPTION

The present invention can be implemented in several ways. One method of implementation is described below. Other methods are described in the attached appendix A, which is incorporated herein by reference

### Overview of Operation

Embodiments of the present invention support three layers of monitoring:

Selected monitoring of applications and their transactions

SQL monitoring through JDBC

Attribute and metric monitoring at a sub-component level.

You may monitor application transactions without making any changes to the application resources deployed in production. SQL monitoring and sub-component monitoring (either within a transaction context or standalone) require configuration changes for specific application resources such as Apache, JBoss, Tomcat, and WebLogic.

Transactions are scripts that define a set of operations within an application that you want to monitor. For example, the present invention can capture a set of browser requests that a user performs and store them as JavaScript. When executed, this script “records” the transaction; the resulting recorded transaction is called a synthetic transaction. Once you have set up the transaction, the present invention monitors its performance and lets you view its performance metrics. You can measure the execution time of the entire recorded transaction, as well as the resource elements that make up the transaction.

SQL Monitoring measures the execution time of SQL statements. Timing is tracked for all SQL statements as they are executed. This requires that you configure your software to use the present invention's JDBC monitoring capabilities as well as the basic configuration.

Bytecode Instrumentation measures the execution time of a method. For each method there are three metrics created.
Error Time: the time spent in the catch statements. This can be very useful if you want to be notified when an error condition occurred.
Normal Time: the time spent outside catch statements
Total Time: Error Time+Normal Time

Performance Measurements are made using an internal timing mechanism. This mechanism depends on the presence of either the timing facilities in the Java Runtime, or the timing facilities in a library that is delivered as part of the normal install. Under all operating systems, this library is installed in \bin. At runtime, if the library is found it is used. If it is not found, the timing facilities in the Java Runtime are used. Either timing mechanism will work, the timing library provides higher granularity (nanosecond resolution under Windows, microsecond resolution under Linux and Solaris). Under Linux and Solaris, you must have libgcc 2.95.3 or higher installed in order to use the high resolution timer.

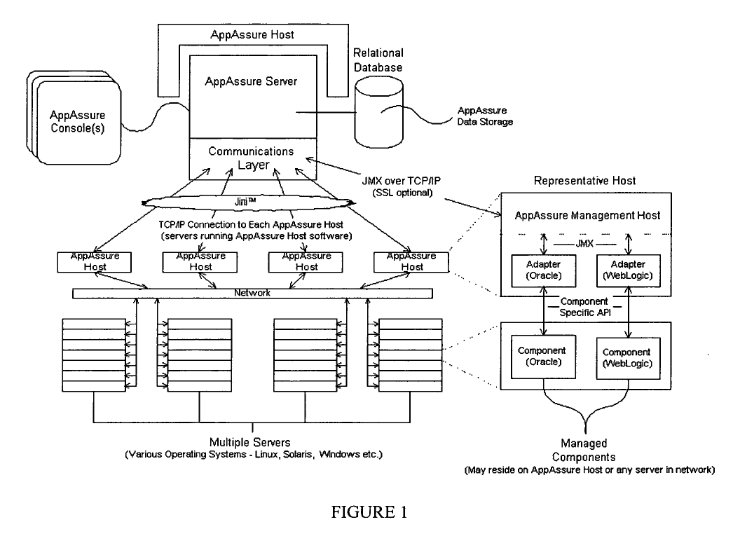

The basic Architecture of one embodiment of the present invention is shown in FIG. 1. There are three main “pieces” to this embodiment of the present invention: the Server, Host and Console. These pieces can be combined to provide the flexibility and scalability to support multiple distributed applications of almost any size.

You may choose to install the Server, Host and Console on hardware also used by the distributed application or they may be installed on dedicated hardware—this is largely a factor of how much computing resource is required by the application monitored by the present invention, and how many monitored elements are desired. This flexibility allows you to isolate the present invention software to systems that do not contain critical application components or data providing completely non-invasive monitoring.

A typical evaluation configuration has all components on a single workstation (“Quick Start”). A typical production configuration has a server and host on one dedicated machine, and console installations on the desktops of those charged with monitoring the application.

### Individual Components

### Application Diagram

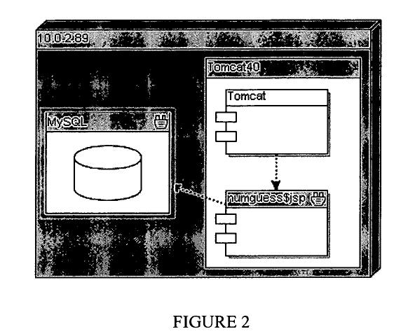

The Application Diagram View Panel displays the Application Diagram Model. This is a visual representation in UML diagram terms of the hosts, resources and components that define the application. It is generated automatically by executing transactions that are part of this application (for example, you can use the Transaction Wizard to record a transaction). The resulting recorded transaction is used to produce a application diagram. The diagram visually displays any dependencies among elements on one or more servers. A simple Application Diagram is shown in FIG. 2.

The application elements that make up the diagram are defined based on the elements in a UML deployment diagram. Host elements are represented as UML hosts. Resource instances are represented as UML resources; resource elements are always contained by (nested within) a host element. Elements are represented as UML components; component elements are always contained by (nested within) a resource instance.

Some application elements and dependency links may have to be added manually. Manually added elements/links are indicated visually in the diagram as having a blue outline, while defined element/links have a black outline. If an element has a thick outline and a diagonal bar in the lower right corner it is collapsed. Component elements can be expanded/collapsed while using the selection tool by double-clicking on an element.

Resource elements and component elements that are associated with a management adapter are indicated by an adapter icon in the right side of the title bar. When a diagram element is associated with an Adapter it allows the diagram element to receive status (for example, Error/Warning/Okay) based on the status of the associated adapter. The current status of each element is displayed visually as the background color of the title bar of each element; the status color will be white if the element is not associated with a management adapter. Status also propagates “up” the nesting of elements; for example, the status of a host is determined by the status of all the resources contained within that host.

### Adapter

The Adapter node represents a single adapter and/or resource that is associated with its parent Host node. The appearance of the adapter's displayed icon is determined by the current status of any monitored attributes or metrics for this adapter.

The use of the term “adapter” generally refers to anything that is a data conduit for a managed resource, whether the resource is an “application” (for example, WebLogic, Apache, etc.), system resource, or a servlet or EBJ.

These are different types of Adapters that appear in the Console (Explorer Panel) tree:

Adapters (sometimes called resource adapters or group adapters)—Adapters monitor resources which may reside on the local system or on any server in the network (including non-Windows systems). Certain Adapters, such as those for Apache, JBoss, Tomcat, WebLogic and SNMP must be configured to point to the appropriate managed resource(s).

Resource Instances—These instances of adapters are the various monitors used by the present invention and some system activities. Since instances may be nested, these objects often appear in the tree as children of other adapter nodes. Adapters and Resource Instances have the same icon appearance in the Explorer Panel tree. However, once “under the covers” they are quite different.

Resource Components—A resource component is a visual representation of a distinct object contained within the managed resource. For example, it may be a specific servlet in a web server, a component in an application server, or a table in a database. It is also a node that may be purely for organizational purposes within the management tree. A resource component node may contain one or more metrics and attributes. Resource Components are added/managed in the same way as Resource Instances.

### Console

The Console provides the user interface to the Distributed Application Management Platform management and monitoring features. It is a cross-platform Java program that can run standalone. There can be multiple consoles on the network. The Console software may be installed on any system connected to the network. In order for the Console to obtain meaningful management information, you should have at least one host and server installed in order to discover and monitor resources on your system.

The managed objects are organized “beneath” the console in a specific hierarchy and are displayed in a tree format in the Explorer Panel (left hand panel) of the main Console window. The Console node is the root of the entire tree and represents the Console itself. Selecting this node displays a standard icon view of its children (Server Nodes) in the View Panel on the right side of the Window.

### Collections

When you have multiple instances of the same Resource Component on your network, it is often advantageous to monitor the same set of attributes and metrics on each of these instances. Collections permit the grouping of a set of instances for replication. Once a collection is created, you may add attributes or metrics to all of the instances in this collection in a single Discover action.

You can manage collections and replication form the following four panels:
Attribute Discovery dialog
Attribute Properties dialog
Metric Discovery dialog
Metric Properties dialog

Once a Collection has been created, selecting the “Apply to Adapter Collection” checkbox performs the replication. When you use the Discovery Panel for replication matters, the default properties for polling rate, status propagation, and units are replicated. If you want to set these values before replication, then add the attribute or metric first, right-click to select Properties, configure it, then replicate. If any attribute or metric already exists in one of the instances, its values for these properties will be overwritten.

Note: Attribute names must match in order for them to be replicated. For example, different versions of MySQL have some slight variations in attribute names. The adapter will display the valid ones for each version, but since the names differ they will not replicate.

| MySQL 3.23.49 | MySQL 3.23.53 |
|---|---|
| Com_show_master_stat | Com_show_master_status |
| Com_show_slave_stat | Com_show_slave_status |

Once a collection is created, you may add attributes or metrics to all of the instances in this collection in a single discover action. Note that even though you may add attributes/metrics across multiple instances, you must still remove them one at a time when you decide to remove them.

### Collector

The Collector appears as a selectable adapter for Hosts within the Management node. The Collector node displays the metrics you are currently monitoring.

The Collector View presents three tabs:

Objects—Presents a standard icon view of the metrics you have added to the collector for monitoring (not, collection of statistics for individual metrics may be enabled/disabled, see below)

Overview—Presents a “flat” view of all of the metrics currently available for monitoring. Attributes being actively monitored show their current status color, disabled metrics appear grey.

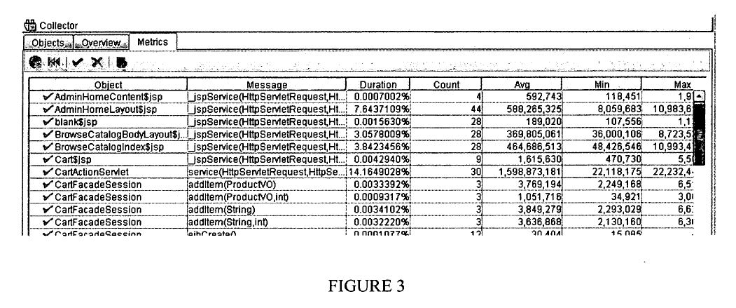

Metrics—The metrics tab view is shown in FIG. 3. The individual fields are identified below:
Object—The metric name. This can be a component (such as an EJB or Servlet), or a SQL query
Message—The specific item that is being measured. For a component, it is a specific component method name. For a SQL query, it is the query string.
Duration—This shows the percentage of time this particular metric occupied in relation to the other metrics surfaced by the Collector since the last time the Collector was reset.
Count—Tracks how many times the metric has been exercised since the last time the Collector was reset.
Avg—Tracks the average execution duration for the particular metric.
Min—Tracks the shortest duration recorded for the particular metric since the last time the Collector was reset.
Max—Tracks the longest duration recorded for the particular metric since the last time the Collector was reset.
Min Time—Tracks the date/time when the shortest duration recorded the particular metric occurred since the last time the Collector was reset.
Max Time—Tracks the date/time when the longest duration recorded the particular metric occurred since the last time the Collector was reset.

### Discovery

Many managed objects have more attributes than you may want to monitor. The Discovery process allows you to define which objects to manage and which attributes of those objects to monitor. When you “add” an attribute that you have discovered, you instruct the present invention to poll it for its status and performance.

You use the Discovery Panel to automatically detect instances and create the appropriate adapter. In some cases the present invention will not be able to locate the instance you are looking for. In these cases you must manually configure the instance before it can be added to the console. The topics below contain instructions on discovery tasks.

### Explorer

The Explorer Panel contains a hierarchical tree of objects (also called tree nodes). The hierarchy of nodes displayed in this panel corresponds to the hierarchy of management information stored in the management database.

The root of the tree is the Console node. Beneath the console node is one or more management server nodes. There should be at least one management server running in order to perform monitoring tasks.

A management server node contains an Applications node (where you define applications and record application transactions you wish to monitor), a Groups node (where you define groups of common definitions to aid monitoring configuration), a Reports node (where you define collections of monitored elements that are graphed in real-time), an Actions node (where you define instances of default actions to take when monitor thresholds are met) and a Scripts node (where you define new actions not pre-packaged for use when monitor thresholds are met), Each of these nodes has detailed explanation elsewhere in the help.

In addition to these nodes, a management server node contains one or more management nodes. A management node is part of the software installation, and each management node corresponds to a specific instance of a management host running on the network. The number of management hosts typically deployed is dependent on a variety of factors including the number of resources to manage, an the capability of the hardware on which the management host is deployed.

An management host node can contain one or more adapter nodes (also called resource adapters). A resource adapter is part of the software installation, and each resource adapter node corresponds to a specific resource adapter that runs inside a specific management host. A resource adapter is responsible for gathering application performance data from the associated managed resource (such as a web server, application server or database). There is a separate adapter for each specific resource, and often for a specific version of a resource.

A resource adapter node may contain one or more resource instance nodes (also called resource instance adapters). Each of these nodes corresponds to a specific instance of the resource monitored by the adapter. Often, an instance is identified by a particular IP address, although this is totally dependent on the type of resource being monitored.

A resource instance adapter node may contain one or more resource component nodes (also called resource component adapters). A resource component is a visual representation of a distinct object contained within the managed resource. For example, it may be a specific servlet in a web server, a component in an application server, or a table in a database. It is also a node that may be purely for organizational purposes within the management tree.

A resource component node may contain one or more metrics and attributes. Metrics are generally a measurement of performance (time to complete). Attributes are generally a status value (CPU Utilization).

### Host

The Host provides the interface for Alignment Software Adapters to communicate with monitored resource elements. (The Console may or may not be installed on the same physical system as an Server/Host or Host.)

### Polling

One of the useful ways to monitor Attributes, Metrics and Transaction is to poll them. The current data value is recorded when the Server polls the Attribute or Metric. This data can be graphed and displayed in the view window, or exported for further analysis. You determine how often the data is sampled by setting a polling value.

Keep in mind that spikes or crashes that occur quickly and then return to a moderate level between polling intervals are not detected. If you think this might happen in your case, you can increase the polling frequency to minimize the amount of time between polling intervals.

In the case of Transactions, each time a transaction is polled the transaction script is executed. If you wish to capture individual transaction data you need to use the snapshot option using the Snapshot tab in the Transaction Properties Dialog.

Important Note: Setting a polling frequency faster than the synthetic transaction can complete may cause serious traffic bottlenecks on your network. We recommend setting a polling frequency to at least 2.5 times the greatest expected elapsed time for the transaction to complete.

### Script Engine

The Script Engine used for the present invention generally supports all the features of JavaScript 1.5 (Standard ECMA-262). Scripts execute on the server (with output sent to console), allows direct scripting of Java (e.g. java.lang.System.out.println (“Hello World”);), and allows use of classes not in the standard java package.

Example Scripts:

/* SendMail.js - Send Email message via SMTP server */
var smtpServer = “yourSMTPserver.yourDomain.com”;// SMTP Server
var useAuthenication =
false;// SMTP Server Requires Authentication? (true/false)
var smtpUser = “”;// SMTP Server Username
var smtpPass = “”;// SMTP Server Password
var to = “someuser@yourDomain.com”;//Recipient Address
var from = AppAssure_Server@yourDomain.com;// Return Address
var subject = “AppAssure Server Message”;// Message Subject
var body = “Message from AppAssure Server”;// Message Body
AppAssure.sendMail (smtpServer, useAuthenication, smtpUser, smtpPass,
to, from, subject, body);

/*Example script that runs the AppAssure event correlation (root cause analysis tool)* and sends and email with the results to a specified user*/

var smtpServer = “smtp.yourDomain.com”; // SMTP Server
var useAuthenication = false; // SMTP Server Requires Authentication?
(true/false)
var smtpUser = “”;// SMTP Server Username
var smtpPass = “”; // SMTP Server Password
var to = “someone@yourDomain.com”; // Recipient Address
var from = “AppAssure_Server @your domain.com”; // Return Address
var subject = “AppAssure Server Message”; // Message Subject
var eventList = “AppAssure.correlateEvents( );
var event;
var body = new String (“Number of Events From
Correlator = ”+eventList.size( )+“\n”);
if(eventList.size( ) > 0)
{
var base = eventList.get ( ).getLikelihood( );
for (i=0;i<eventList.size( );i++)
{
event = eventList.get(i);
body += “Likelihood = ”+ ((event.getLikelihood( )*90)/base) +“%\n”;
body += “Host = ”+ event.getName( )+“\n”;
body += “Name = ”+ event.getName( )+“\n”;
body += “Status = ”+ niceStatus (event.getStatus( ))+“\n”;
body += “Time = ”+ niceStatus (event.getTime( ))“\n”;
body += “Reason = ”+ event.getReason( )+“\n”;
body += “\n\n”;
}
}
AppAssure.sendMail (smtpServer,useAuthenication, smtpUser, smtpPass,
to, from, subject, body);
function niceStatus(number)
{
if (number == AppAssure.STATUS_OFFLINE)
return “Offline”;
else if (number == AppAssure.STATUS_Error)
return “Error”;
else if (number == AppAssure.STATUS_WARNING)
return “Warning”;
else if (number == AppAssure.STATUS_OKAY)
return “Okay”;
else if (number == AppAssure.STATUS_UNKNOWN)
return “Unknown”;
}
function niceTime (nano)
{
return (new java.util.Date(nano)).toString( );
}

### Security

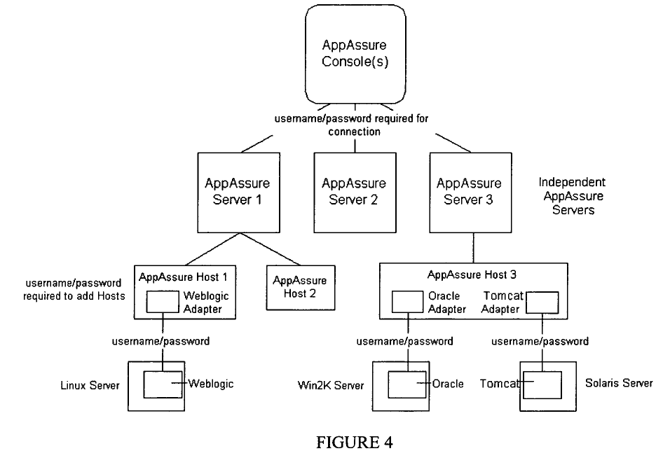

Embodiments of the present invention generally provide basic security both at the user and component levels as shown in FIG. 4. Ebmodiments of the present invention can provide support for a single console to connect to multiple, independent Servers. When a user selects a Server at the Console, they are prompted for a user/password before they are allowed to view anything on that Server.

At the Adapter/Resource level, embodiments of the present invention generally require a password/username in order to communicate with the resource. This must be provided at the time the adapter is configured.

### Server

The Server is a dedicated server running the Management Host and Server software. The communications layer provides both a Jini and a TCP/IP interface to all of the hosts monitored by this Server. There can be multiple Servers on the same network, or they can be spread across several networks. If you have a small network, you can get by with a single Host/Server combination. Each Server is, in reality, an Host with the Server software running under it.

Servers are generally unknown to each other, but may all be known to a single Console, as long as the system the Console is running on has a network connection to each of the Servers.

The Server architecture is based on and compatible with the Java Management Extensions (JMX). All management operations and console communications are performed using JMX. The Server maintains its data in an embedded relational database accessed through standard Java Database Connectivity (JDBC) drivers. Embodiments of the present invention are installed with an embedded MySQL database, but you have the option to use another MySQL or Oracle external database if desired by using the Server Administration Dialog.

The Server contains an embedded proxy server. When you are preparing to record a transaction you will set up your browser to use this proxy server. As you create a transaction record, the proxy server captures the browser request and stores them in a Java Script that is used to generate a synthetic transaction.

### SQL Monitoring

Heavy database activity is not often the source of bottlenecks and slowdown. However, when DB activity is slowing you down, it is good to have a tool that allows you to zero in on the problem. Embodiments of the present invention provide SQL Activity monitoring by component. For example, a specific instance of WebLogic interacts with an Oracle database. Other components may also use this database, and overall database activity is determined by more than just WebLogic. Since the present invention monitor uses the WebLogic JDBC driver to determine which SQL to monitor, you can list the minimum, maximum and average execution times for all SQL statements between WebLogic and Oracle. Sorting on the maximum execution time field provides instant access to possible “bottleneck” SQL Activity. The time stamps for these maximum times also provide valuable information.

### Status Levels

Embodiments of the present invention detect and reports on the status of the objects it monitors, and displays the current status of the object in the Explorer Panel and View Panel using an icon with a particular color and shape.

Status ripples upward from the lowest child nodes (leaf nodes) to other nodes in the tree structure of the object, all the way to the host or application. The state for the leaf propagates upward based on the lowest node with the condition. The hierarchy of status is that Error overrides Warning overrides OK overrides Unknown. If an attribute goes into an error, warning or unknown state, the icon for that attribute reflects the new status by changing color as does the Adapter, Host and Management above that attribute in the tree. Metrics and Transactions are also leaf nodes with respect to status.

If the Adapter instance associated with the attribute is currently showing a lower state, its status indicator changes to reflect the state of the attribute. (For example, an attribute is in error and goes red. If the resource instance for this attribute is currently yellow or green, it will go red. However, if an attribute turns yellow to indicate a warning state, but the resource instance is currently red for some other reason, no color change occurs to the component icon.)

This continues all the way up to the Host. Status is also reflected in Applications. If a Host goes red, all Applications that include that Host go red as well. Status change is dynamic. When an attribute goes back to a lower state, its status indicator also reflects this change. To track error and warning states historically, you can view them in the Events Panel.

You can change the definitions for each status type and create an action/response to perform when an object enters a particular state. The status is evaluated each time a metric, attribute or transaction node is polled using the performance data retrieved at that time. If the expression evaluates to a logical TRUE, a status change event is generated and carries the status level associated with the expression.

Status changes generate events. Actions and Scripts may be specified as responses to status changes (events) via the Status tab on the Properties Dialog for items that support this feature.

### Transactions

Embodiments of the present invention allow you to monitor transactions the sub-component level. Transactions are created as children of specific Applications. You select the Record Transaction option and then execute the desired requests at a browser to complete the desired transaction. Embodiments of the present invention tracks the internal path of this transaction at the sub-component level. In addition, the software captures the browser requests and stores them as a Java Script. This script can be executed to generate a synthetic transaction. Synthetic transactions can be monitored in real time or set to execute as a specific interval. Historical data collected from this “transaction polling” can be graphed and studied.

The relationships discovered between components based on these transactions are captured in the Application Diagram. The more complete your library of transactions, the more complete the application model created.

The transaction data is displayed in the View Panel as a UML Sequence diagram. The UML Sequence Diagram represents the monitored transaction. In the diagram, vertical lines represent objects, boxes represent methods and arrowed lines represent calls and returns. A more detailed “key” to the diagram content is contained in the related topics listed below for the Transaction View Panel.

The first method shown in the display is the root or threshold method. This is where the actual elapsed time for the transaction is displayed. You can view a transaction in real time or you can view historical data saved at intervals specified in the transaction record's properties file. If other methods in this transaction happen to be root methods for other transactions, their times will also be included in the display.

The total time for the transaction to execute is calculated as a average of the time required for executions of this transaction during the polling interval. Also, this average time may include other activity beyond the monitored transaction if the root method is also involved in other transactions (which is often the case). What we are actually measuring is the activity of the threshold method. This will not be the case in future releases.

What is claimed is:

1. A system for monitoring applications comprising:
means for monitoring applications and corresponding transactions; and
means for monitoring SQL through JDBC; and
means for monitoring metrics at a sub-component level.
